(19) United States
(12) Patent Application Publication
(10) Pub. No.: US 2006/0037996 A1
(43) Pub. Date: Feb. 23, 2006

(54) Pre-treatment of galvanized steel sheets and aluminum plates for improved weldability

(75) Inventors: Uwe Weinzierl, Jena (DE); Norbert Preuss, Jena (DE); Klaus Loeffler, Calberlah (DE); Florian Hanschmann, Braunschweig (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Jenoptik Automatisierungstechnik GmbH, Jena (DE)

(21) Appl. No.: 11/148,957

(22) Filed: Jun. 9, 2005

(30) Foreign Application Priority Data
Jun. 9, 2004 (DE) 10 2004 028 197.1

(51) Int. Cl. B23K 31/02; B23K 20/24; B23K 1/20

(52) U.S. Cl. 228/203

(57) ABSTRACT

A method for the improvement of welding properties of galvanized steel panels by pretreatment of the surface in the joint zone provided for the welding connection in which a stream of an atmospheric low-temperature plasma is directed onto the surface.

### CROSS-REFERENCE TO RELATED APPLICATION

This application claims priority of German Application No. 10 2004 028 197.1 filed Jun. 9, 2004, the complete disclosure of which is hereby incorporated by reference.

### BACKGROUND OF THE INVENTION

a) Field of the Invention

This application claims priority of German Application No. 10 2004 028 197.1, filed Jun. 9, 2004, the complete disclosure of which is hereby incorporated by reference.

b) Description of the Related Art

The invention relates to a method for the pretreatment of galvanized steel panels or aluminum panels for welding, in particular for laser welding. The term “galvanized steel panels” should be understood to also include steel panels whose applied protective layer contains only some zinc. In particular, zinc-aluminum and zinc-nickel alloys or even organic materials such as, for example, a zinc dust lacquer or a plastic to which zinc has been added are considered.

It is known that during the welding of galvanized steel panels, quality problems arise in the region of the welding seam unless additional measures are taken. Because the zinc begins to melt at substantially lower temperatures than the steel panel and vaporizes, contractions and cracks occur around the welding seam, resulting in a lower degree of sturdiness and impermeability of the welding seam as well as a susceptibility to corrosion and a corrupted structure of the welding seam.

Known methods include a large number of diverse measures that attempt to improve the quality of the resulting welding seam.

European Patent No. 0 527 229 B1 describes a method for laser welding, in particular of galvanized steel panels, in which an auxiliary gas containing oxygen and one other gas, which is mixed before the welding process, is used during the welding process.

The oxygen gas bonds with the zinc, forming zinc oxide and zinc peroxide, i.e., solids, while suppressing the vaporization of the zinc, which should cause noticeably fewer contractions.

European Patent No. 0 446 677 B1 describes a method for the production of a galvanized steel panel with improved welding properties in which, before the precipitation of the zinc layer onto the surface of the steel panel, an iron/carbon layer with a certain carbon content is applied to the surface of the steel panel.

The related art described in this document is determined by two Japanese patent applications, in each of which the welding properties of a galvanized steel panel are improved by the formation of an oxide film on the galvanized surface.

This oxide film is applied to a galvanized steel panel described in Japanese Patent Application No. 60-063394 or 02-004983 by hot dipping.

The author of European Patent No. 0 446 677 B1 declares that experiments in which an oxide film was formed on zinc-plated steel panels have failed up to now insofar as it was not possible to obtain satisfactory results on an industrial scale.

Galvanized steel panels are used for automobile bodies, industrial containers, and housings for domestic appliances, in particular.

The use of galvanized steel panels is continually increasing, especially in the automobile industry, in particular because applied coatings adhere to them well and they are highly resistant to corrosion. In this industry, in which there are few remaining differences between competitors in terms of product quality and technology level, the competitive race is decided primarily by production costs. Because of the immense number of items that must be manufactured, even small savings of time and materials can make a difference. Therefore, shortening the production cycle for manufacturing an automobile is a perpetual goal, which is possible, for example, by the substitution of processes that are less time-consuming and by the prevention of technologically necessary downtime. Moreover, manufacturers endeavor to have the equipment that is required for the production process be as sturdy and low-maintenance as possible. Finally, it is possible to reduce production costs by using auxiliary materials sparingly.

If the solutions offered by the related art described above are regarded in this light, it becomes apparent that each of these solutions requires a considerable expenditure in order to be able to weld a galvanized steel panel in a manner that meets quality requirements, i.e., that does not cause contractions to form and does maintain the zinc layer around the welding seam.

The use of an auxiliary gas during laser welding (European Patent No. 0 446 677 B1) requires specially structured welding tips with which generally the gas stream is directed onto the work piece coaxially to the laser beam. In contrast to laser welding equipment that works without auxiliary gas, additional technical measures must be employed here regarding the gas supply and the gas exhaust.

The other solutions listed above require the additional application of a layer. By virtue of the process, this layer is applied to the entire surface, i.e., also in regions of the surface that are not at all intended to be a joining area for a later welding connection. The amount of material consumed by the application of the layer is therefore many times greater than is actually functionally required. In addition, hot dipping, for example, requires cooling and drying time.

According to the description of the related art in German Patent No. 101 35 611 A1, special electrodes that are often expensive and generally operate with a reduced welding current are used to reduce vaporization. However, under certain conditions, this impairs the mechanical loading capacity of the welding connection and reduces the throughput of such a production facility.

In other methods, special structural measures are taken in order to allow the resulting process vapors to escape unhindered.

In the light of this related art, German Patent No. 101 35 611 A1 offers the solution of using an abrasive to partially remove or considerably reduce the anti-corrosion layer (zinc layer). According to this document, a miniaturized sandblasting compressor such as one that is used, for example, in dentistry for the removal of deposits on teeth, is suitable for removing the zinc layer in the region of the welding seam (joint zone). In order to prevent impurities in the surrounding surface and to be able to reuse the abrasive, extraction measures should be taken, for example, by using a negative-pressure blasting device.

Reference is explicitly made to the fact that this method is also suitable for welding using a laser and that, especially in the construction of automobile bodies, surfaces of the automobile body panels lying directly on one another may be safely welded after prior treatment with a negative-pressure blasting device.

Mineral corundums are recommended as appropriate blasting media. Glass, salts, natron, ground nutshells, ice, or dry ice are mentioned as being conceivable; the latter media are described as having the advantage that no residue of blasting media need be removed. The method claimed by German Patent No. 101 35 611 A1 does not have a disadvantageous effect on the corrosion properties as compared to the related art because the zinc layer vaporizes in the region of the welding seam in any event.

In order to improve the welding properties of electrically conductive work pieces made of easily oxidized metals that tend to form surface layers that hinder the welding process, German Patent No. 199 27 557 A1 suggests producing a high-frequency arc discharge that jumps onto the surface and perforates and partially vaporizes the disruptive surface layer at randomly distributed points.

### OBJECT AND SUMMARY OF THE INVENTION

The primary object of the invention is to find appropriate measures for improving the welding properties of galvanized steel panels that require the lowest possible technical, time, and material expenditure.

This object is attained using a method for improving the welding properties of galvanized steel panels or aluminum panels by pretreatment of the surface in the joint region provided for the welding by virtue of the fact that a stream of an atmospheric, electrically neutral, low-temperature plasma is directed onto the surface.

### DESCRIPTION OF THE PREFERRED EMBODIMENTS

The use of an atmospheric low-temperature plasma for surface treatment is not novel per se.

European Patent No. 0 761 415 B1 suggests a method for increasing the wettability of the surface of tools with fluids in which a stream of a reactive medium is produced by a plasma discharge while a working gas is being supplied and applied to the surface to be treated. In contrast to methods for plasma production known from related art, the plasma has a relatively low temperature for surface treatment so that it is not able to damage even sensitive surfaces. According to this patent, this method is appropriate for the treatment of conductive as well as non-conductive work pieces, in particular work pieces made of plastic.

A stream generator, which is able to produce an atmospheric low-temperature plasma that is appropriate for performing the method and which is used for the pretreatment of plastics with a non-transferable arc, is described in European Patent No. 0 761 415 B1. Just as in a stream generator as is described in European Patent no. 1 292 176 A2, the electrical arc produced in order to generate the plasma is not transferred to the work piece. Experiments were conducted to ascertain the physical and chemical properties of the plasma stream leaving the stream generator, the results of which are reported in European Patent No. 0 761 415 B1.

It is not certain from these experiments whether the plasma in question is truly a plasma in the usual sense, i.e. an at least partially ionized medium, or if it contains only free radicals or excited atoms or molecules.

In any case, it was possible to verify that the plasma stream had the desired pretreatment effect on the work piece surface. Various plastic surfaces, which are not normally wettable with water, were placed in the plasma stream. Subsequently, it was possible to wet them with water. It was reported that it was also possible, for example, to remove silicon residues and similar substances from metal surfaces with the aid of the plasma stream. In experiments with base metals, for example, aluminum, it was shown that the plasma stream has practically no oxidizing effect, i.e., it does not form an oxide layer that is thicker than is natural.

The introduction of European Patent No. 1 292 176 A2 lists applications for which the electrically neutral plasma stream generated by the stream generator claimed therein would be appropriate. According to this document, the plasma stream is appropriate for the treatment of surfaces, for example, for pretreating and cleaning surfaces before adhesion, coating, or lacquering; for coating, rendering hydrophilic, removing electric charges, or sterilizing; as well as for accelerating chemical reactions. Although it is not explicitly stated in European Patent No. 1 292 176 A2, one skilled in the art is able to draw the conclusion from the list of possible applications that the plasma stream may be used to remove any materials adhering to the surface.

European Patent No. 0 761 415 B1 and European Patent No. 1 292 176 A2 do not offer any approach that would render it obvious to one skilled in the art to pretreat a galvanized steel panel for welding.

Such an application is surprising to the Applicant as well, although the Applicant has been purchasing stream generators manufactured according to European Patent No. 1 292 176 A2 for years for the purpose of integrating them into mechanical equipment. According to the possible applications cited in the related art, the stream generators are used in cleaning equipment for electrical components and circuits as well as in equipment for the activation of plastics to improve their adhesiveness.

In one experiment, the surfaces of two galvanized steel panels to be welded with a fillet weld were treated with a plasma stream as produced by a stream generator according to European Patent No. 1 292 176 A2. Specifically, steel panels were used with an approximately 5 μm thick galvanically deposited zinc layer. Air was used as a process gas in one experiment and a nitrogen-oxygen mixture was used in another. The outlet of the stream generator was guided at a distance of 12 mm+/−2 mm from the surface of the steel panels and with a speed of 80 mm/s+/−10 mm/s.

Both panels were subsequently welded using a laser in a manner known to one skilled in the art. Very good results were attained, for example, with an Nd-YAG laser at a maximum applied output of 2.5 kW.

Given the same process parameters, the effects occurring during welding and the welding result are different for steel panels that were not pretreated and steel panels that were pretreated according to the present invention.

Thus, much smaller amounts of process vapors occur during welding of the pretreated steel panels.

The resulting welding seam has a considerably improved welding seam surface and has far fewer contractions and cracks. Moreover, the welding seam has fewer scales.

It has been shown that welding seams of a comparably good quality result even if only one of the two steel panels to be welded has been pretreated with the plasma stream in the surface region designated for welding (joint zone).

It is presumed that the effect of the plasma stream alters the zinc layer in such a way that it begins to melt only at higher temperatures.

In comparison to the known related art for improving the welding quality when welding galvanized steel panels, the pretreatment according to the present invention has the advantage that it requires less technical, time, and material expenditure and is therefore a cost-effective alternative, in particular in the case of highly automated large-series production.

Surprisingly, it was found that even in the case of aluminum panels, surface treatment with an atmospheric low-temperature plasma in the joint zone provided for the welding connection leads to an improvement in welding properties.

While the foregoing description and drawings represent the present invention, it will be obvious to those skilled in the art that various changes may be made therein without departing from the true spirit and scope of the present invention.

What is claimed is:

1-4. (canceled)

5. A method for improving the welding properties of galvanized steel panels or aluminum panels by pretreatment of the surface in the joint region provided for the welding connection, comprising the step of directing a stream of an atmospheric, electrically neutral, low-temperature plasma onto the surface.

6. The method as recited in claim 5, wherein the plasma is electrically ignited.

7. The method as recited in claim 5, wherein air is used as the process gas for generating the plasma.

8. The method as recited in claim 5, wherein only the surface of one of the two galvanized panels to be welded to one another is pretreated.
